(19) United States
(12) Patent Application Publication
(10) Pub. No.: US 2025/0140004 A1
(43) Pub. Date: May 1, 2025

(54) METHODS AND SYSTEMS FOR FACILITATING ANNOTATION OF VIDEOS

(71) Applicant: Toyota Jidosha Kabushiki Kaisha, Toyota-shi (JP)

(72) Inventor: Daniel F. Pontillo, Rochester, NY (US)

(73) Assignee: Toyota Jidosha Kabushiki Kaisha, Toyota-shi (JP)

(21) Appl. No.: 18/498,153

(22) Filed: Oct. 31, 2023

(51) Int. Cl. G06V 20/70; G06V 10/82; G06V 20/40

(52) U.S. Cl. CPC G06V 20/70; G06V 10/82; G06V 20/46; G06V 2201/07

(57) ABSTRACT

A system and method include a processor and a non-transitory, computer-readable medium storing one or more neural networks. The processor is operable to extract, using the trained neural networks, frames in a video for annotation based on an annotation task selected by a user, assign, using the trained neural networks, the annotation task to one or more annotators based on matchability scores and historical annotation performance of the annotators, determine, using the trained neural networks, whether one or more confidence scores of one or more annotations in annotated frames received from the one or more annotators are below a threshold, in response to a determination that the one or more confidence scores are below the threshold, flag the one or more annotations associated with the one or more confidence scores below the threshold, and send notifications of the flagged annotations to the user.

### TECHNICAL FIELD

The present disclosure relates to computer-assisted video processing technologies, and more particularly, to computer-assisted video processing technologies for video annotation.

### BACKGROUND

Video annotation tasks require human workers to watch and annotate videos with specific information, including labeling, categorizing, or identifying specific objects, people, or events in a video. Video annotation tasks can be time-consuming and labor-intensive. Therefore, a need exists for facilitating annotation by assisting humans or automated systems to provide annotating guidelines, video preprocessing, consistency checks, and quality control.

### SUMMARY

In a first aspect, a method for facilitating human annotation of videos includes extracting, using one or more trained neural networks, frames in a video for annotation based on an annotation task selected by a user, assigning, using the one or more trained neural networks, the annotation task to one or more annotators based on matchability scores and historical annotation performance of the annotators, determining, using the one or more trained neural networks, whether one or more confidence scores of one or more annotations in annotated frames received from the one or more annotators are below a threshold, in response to a determination that the one or more confidence scores are below the threshold, flagging the one or more annotations associated with the one or more confidence scores below the threshold, and sending notifications of the flagged annotations to the user.

In a second aspect, a system for facilitating human annotation of videos includes a processor and a non-transitory, computer-readable medium storing one or more neural networks. The processor is operable to extract, using one or more trained neural networks, frames in a video for annotation based on an annotation task selected by a user, assign, using the one or more trained neural networks, the annotation task to one or more annotators based on matchability scores and historical annotation performance of the annotators, determine, using the one or more trained neural networks, whether one or more confidence scores of one or more annotations in annotated frames received from the one or more annotators are below a threshold, in response to a determination that the one or more confidence scores are below the threshold, flag the one or more annotations associated with the one or more confidence scores below the threshold, and send notifications of the flagged annotations to the user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example system for facilitating annotation of videos, according to one or more embodiments shown and described herein;

FIG. 2. schematically depicts non-limiting components of the devices of the system for facilitating annotation of videos, according to one or more embodiments shown and described herein;

FIG. 3 schematically depicts an example graphical representation of facilitating annotation of videos, according to one or more embodiments shown and described herein;

FIG. 4 schematically depicts an example graphical representation of training the system for facilitating annotation of videos, according to one or more embodiments shown and described herein; and

FIG. 5 illustrates a flow diagram of illustrative steps for facilitating annotation of videos, according to one or more embodiments shown and described herein.

### DETAILED DESCRIPTION

The embodiments described herein are directed to methods and systems for facilitating the annotation of videos. The facility system for video facilitation includes various trained machine learning algorithms that assist a user in preprocessing and segmenting videos into frames, selecting annotators based on annotation tasks, and conducting annotation quality control.

Video annotation tasks require human workers to watch and annotate videos with desirable information. Video annotation involves labeling, categorizing, or identifying specific objects, people, or events in an image or a video. For example, video annotation tasks may include identifying and labeling objects or people in a video, transcribing audio or speech in a video, tracking the movement of objects or people in a video, and identifying specific events or actions that occur in a video. A desirable annotator may have a good understanding of the annotation requirements and be able to watch and analyze the video carefully. The annotators may need to use tools such as annotation software, frame-by-frame video playback, and time-stamping to ensure acceptance and consistency in their annotations. In many cases, video annotation tasks are time-consuming and labor-intensive. Accordingly, it is desirable for the current facilitation system and method to help a user preprocess a video and segment frames out from the video based on a selected task, screen and select annotation platform and annotators to perform the annotation task, and perform quality control over the annotation.

The facilitation system and method for video annotation enhance the efficiency and quality of video data labeling processes by providing the following features. By providing annotators with specialized tools, clear guidelines, and efficient workflows, facilitation reduces undesirable results and ensures consistency in annotations. Accordingly, the system and method leads to high-quality labeled datasets, benefiting machine learning, computer vision, and artificial intelligence (AI) projects by improving model performance and reducing the need for labor-intensive manual checks. Furthermore, facilitation streamlines the entire process, making it more time and cost-efficient, especially when dealing with extensive video datasets. The system and method promote scalability, allowing organizations to handle larger volumes of video data without compromising on quality.

Various embodiments of the methods and systems for sharing detected changes of roads using blockchains are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

As disclosed herein, an annotation task refers to a task of adding metadata, tags, or labels to contents, such as, without limitations, text, audio, images, video. The contents may be computer-readable or converted into a computer readable format.

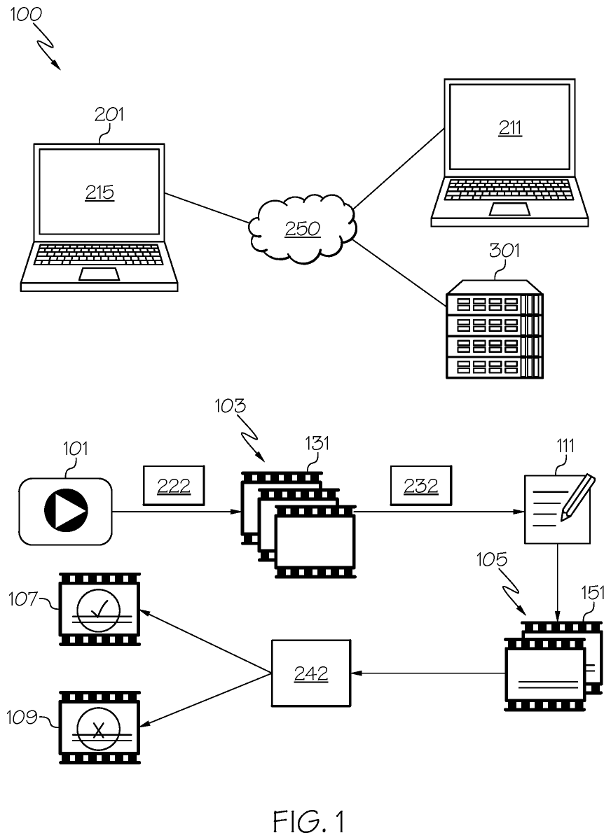

FIG. 1 generally depicts one embodiment of an annotation facilitation system 100. The annotation facilitation system 100 includes one or more controllers 201. The controller 201 of a user may connect a server 301 or an annotator controller 211 through a network 250

In embodiments, the controller 201 or the annotator controller 211 may be, without limitation, a computer, a laptop, a cell phone, a smartphone, a tablet, a wearable device such as a smartwatch or fitness tracker, a web-based messaging platform, or a voice assistance.

The controller 201 may include a user interface 215. The user may use the user interface 215 to, without limitations, select a video to be annotated, select one or more annotation tasks for the video 101, review proposed annotation platform and/or annotators, review any progress of the annotation tasks, review flagged annotations, and review annotation results. The user interface 215 may include, without limitation, input controls, display area, navigation elements, feedback and validation, dialogs and modals, layouts, and other components. In embodiments, the user interface 215 may include an input control for the user to provide input to the controller 201, such as, without limitation, text fields, checkboxes, radio buttons, dropdown menus, sliders, buttons, and touch gestures. The user interface 215 may further include a display area to present information, feedback, or output to the user, including elements such as, without limitation, text, images, icons, charts, graphs, tables, notifications, and status indicators. The user interface 215 may also include a navigation element for the user to move through different sections or screens within the user interface 215. The navigation element may include, without limitation, menus, tabs, breadcrumbs, sidebars, and hyperlinks. The user interface 215 may include feedback and validation to provide the user with information about the outcome of their actions or the current state of the annotation facilitation system 100. Feedback or validation may include, without limitation, tooltips, error messages, success notifications, progress bars, and validation indicators. The user interface 215 may include dialogs and modals as temporary pop-up windows that prompt the user for specific input, display additional information, or require users to make decisions.

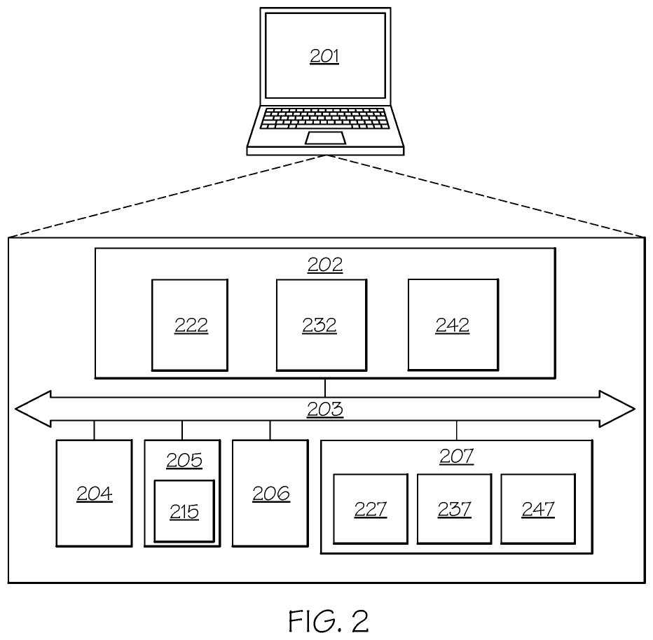

In embodiments, the controller 201, the annotator controller 211, and the server 301 may include a network interface hardware 206 (as shown in FIG. 2) and communicate with each other via the network 250. The controller 201 may transmit, without limitations, sequence frames 103 including one or more frames 131 extracted from a video 101, annotation tasks including one or more guidelines, request for annotation progress, and notification of flagged annotations, to the annotator controller 211 or the server 301, through the network 250. The annotator controller 211 or the server 301 may transmit, without limitations, the acceptance of annotation tasks, annotation progress, and annotated frames to the controller 201, through the network 250.

In embodiments, the network 250 may include one or more computer networks (e.g., a personal area network, a local area network, or a wide area network), cellular networks, satellite networks and/or a global positioning system and combinations thereof. Accordingly, the controller 201, the annotator controller 211, or the server 301 may be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB. Z-Wave, ZigBee, and/or other near field communication protocols. Suitable cellular networks include, but are not limited to, technologies such as LTE, WiMAX, UMTS, CDMA, and GSM.

Still referring to FIG. 1, the annotation facilitation system 100 may include a frame segmentation module 222 to preprocess the video 101. In embodiments, the user may select a video 101 and one or more annotation tasks for the video 101. The annotation tasks may include one or more guidelines for the annotation. The guidelines may include task description, type of data to be annotated, annotation format, instruction on specific situations (e.g. how to handle ambiguous cases), tools/software to be used, or other guidelines used during an annotation. In response to the user selecting the video 101 and an annotation task associated with the video 101, the frame segmentation module 222 may segment the video 101 into sequence frames 103 including one or more frames 131 based on the selected tasks.

In some embodiments, the annotation tasks may be, without limitations, a text annotation task, an image annotation task, an audio annotation task, a video annotation task, a geospatial annotation task, a time series annotation task, a semantic annotation, or an ontology annotation. An image annotation task or a video annotation may include, without limitations, object detection (e.g. annotating objects within images and drawing bounding boxes around), image/frame segmentation (e.g. segmenting an image or a frame of a video into different regions and labeling each region with the object it contains), image/frame classification (e.g. assigning labels or categories to images or frames based on the content therein), facial recognition (e.g. annotating faces in images and identifying individuals), video/frame object tracking (e.g. annotating and tracking objects or people within a video in various frames, usually in continuous frames), action recognition (e.g. annotating actions or events occurring in an image or a video/frames sequence), or a scene classification (e.g. labeling different scenes or locations in an image or a video/frames).

In some embodiments, the annotation tasks may be selected from object recognition and detection, segmentation, pose estimation, action recognition, attribute recognition of people, or a combination thereof. The object recognition and detection may include identifying specific objects or categories within an image or video, and locating, tagging, or/and labeling them within the image or video, for example, by drawing bounding boxes around detected objects. The segmentation may be an image/frame segmentation or a semantic segmentation. The image/frame segmentation may include dividing an image into desirable segments or regions for understanding the spatial layout of objects within an image. The semantic segmentation may assign a class label to each pixel in an image and label each pixel with the object or category it belongs to. The pose estimation may include determining a 2D or a 3D pose (position and orientation) of objects or people within an image or video based on body positions and gestures. The action recognition may include identifying and classifying the actions or activities performed by individuals or objects in a sequence of frames or a video. The attribute recognition of people may include identifying specific attributes or characteristics of people, such as, without limitations, gender, age, clothing color, and accessories.

The annotation facilitation system 100 may include an assignment module 232 to recommend and/or select one or more annotation platforms and/or one or more annotators 111, based on the selected tasks. The annotation platform may be an artificial intelligence based platform (such as Supervisely, Scale AI, Amazon SageMaker Ground Truth, etc., where the annotators are non-human) or a human annotation based platform (e.g. Amazon Mechanical Turk, Clickworker, Scale AI, where the annotators are humans or crowdsourcing). The assignment module 232 may further recommend and/or select one or more annotators from the selected annotation platforms. In embodiments, the user may review the recommendation and affirm the selection, or select different annotation platforms and/or annotators. The assignment module 232 may transmit the video 101 or the sequence frames 103 to the selected annotators 111. For non-human annotators, the video 101 or the frames 103 may be sent to the server 301. For human annotators, the video 101 or the frames 103 may be directly sent to the annotator controller 211, or sent to the server 301 for the further distribution to the annotators 111. The assignment module 232 may further monitor the performance of the annotators 111 and progress of the annotation tasks.

The annotation facilitation system 100 may further include a quality control module 242. The annotators 111, upon finishing the assigned annotation tasks, may send annotated sequence frames 105 including one or more annotated frames 151 back to the controller 201 via the network 250. The quality control module 242 may conduct a quality check over the annotated frames 151 and determine whether the annotations in the annotated frames 151 comply with the task guidelines and whether the annotations satisfy one or more threshold requirements. The quality control module 242 may flag the one or more annotations in the annotated frames 151 when the quality control module 242 determines that the annotations are of low quality, such as a confidence score below a threshold value. A flagged annotated frame 109 may be notified to the user or/and the annotator 111 who generates the associated flagged annotated frame 109. The user and/or the annotator 111 may review the flagged annotation and conduct further actions, such as annotation corrections. In determining that an annotated frame does not include any low-quality annotations, the frame may be labeled as a non-flagged frame 107.

Referring to FIG. 2, non-limiting components of the controller 201 are depicted. The controller 201 may comprise various components, such as a memory component 202, a processor 204, an input/output hardware 205, a network interface hardware 206, a data storage component 207, and a local interface 203. The annotation facilitation system 100 may further include various modules, such as the frame segmentation module 222, the assignment module 232, and the quality control module 242.

The controller 201 may be any device or combination of components comprising a processor 204 and a memory component 202, such as a non-transitory computer readable memory. The processor 204 may be any device capable of executing the machine-readable instruction set stored in the non-transitory computer readable memory. Accordingly, the processor 204 may be an electric controller, an integrated circuit, a microchip, a computer, or any other computing device. The processor 204 may include any processing components configured to receive and execute programming instructions (such as from the data storage component 207 and/or the memory component 202). The instructions may be in the form of a machine-readable instruction set stored in the data storage component 207 and/or the memory component 202. The processor 204 is communicatively coupled to the other components of the controller 201 by the local interface 203. Accordingly, the local interface 203 may communicatively couple any number of processors 304 with one another, and allow the components coupled to the local interface 203 to operate in a distributed computing environment. The local interface 203 may be implemented as a bus or other interface to facilitate communication among the components of the controller 201. In some embodiments, each of the components may operate as a node that may send and/or receive data. While the embodiment depicted in FIG. 2 includes a single processor 204, other embodiments may include more than one processor 204.

The memory component 202 (e.g., a non-transitory computer-readable memory component) may comprise RAM, ROM, flash memories, hard drives, or any non-transitory memory device capable of storing machine-readable instructions such that the machine-readable instructions can be accessed and executed by the processor 204. The machine-readable instruction set may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory component 202, other embodiments may include more than one memory component. Such program modules may include, but are not limited to, routines, subroutines, programs, objects, components, and data structures for performing specific tasks or executing specific abstract data types according to the present disclosure as will be described below.

The memory component 202 may include various modules, such as the frame segmentation module 222, the assignment module 232, and the quality control module 242. The various modules may be trained and provided machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden layers, and node outputs, and may be utilized with activation functions in the one or more hidden layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The one or more ANN models may employ a combination of artificial intelligence techniques, such as, but not limited to, Deep Learning, Random Forest Classifiers, feature extraction from audio, images, clustering algorithms, or combinations thereof. In some embodiments, a convolutional neural network (CNN) may be utilized. For example, a CNN may be used as an ANN that, in a field of machine learning, for example, is a class of deep, feed-forward ANNs applied for audio analysis of the recordings. CNNs may be shift or space invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model, which are trained simultaneously through a competitive process. The generative artificial intelligence algorithm may be based on variation autoencoder (VAE) or transformer-based models (such as generative pre-trained transformer and bidirectional encoder representations from transformers).

The input/output hardware 205 may include a monitor, keyboard, mouse, printer, camera, microphone, speaker, and/or other device for receiving, sending, and/or presenting data. The input/output hardware 205 may include the user interface 215. The network interface hardware 206 may include any wired or wireless networking hardware, such as a modem, LAN port, Wi-Fi card, WiMax card, mobile communications hardware, and/or other hardware for communicating with other networks and/or devices.

The data storage component 207 stores data, such as historical frame and video data 227, historical annotator assignment data 237, and historical annotation data 247. The data storage component 207 may also store data generated by the various modules, such as the frame segmentation module 222, the assignment module 232, and the quality control module 242.

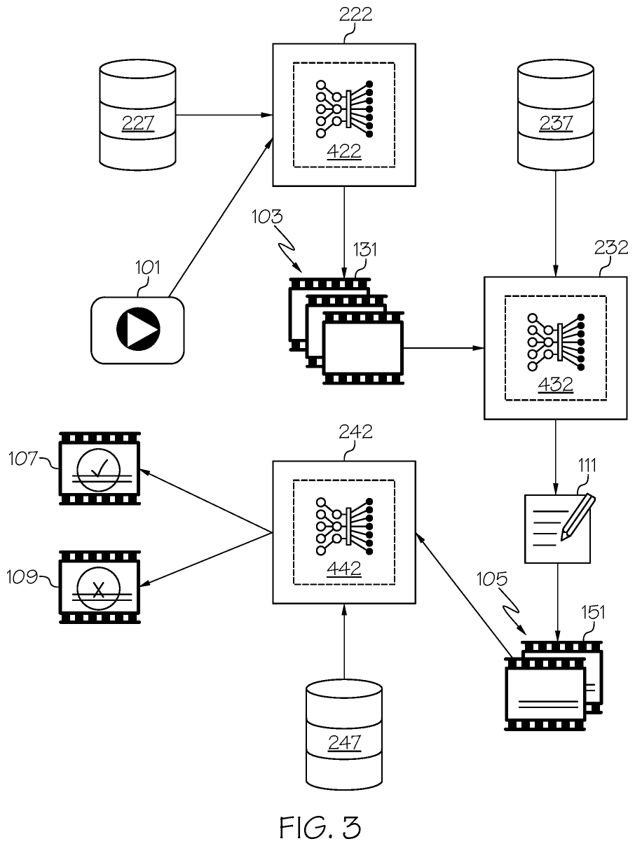

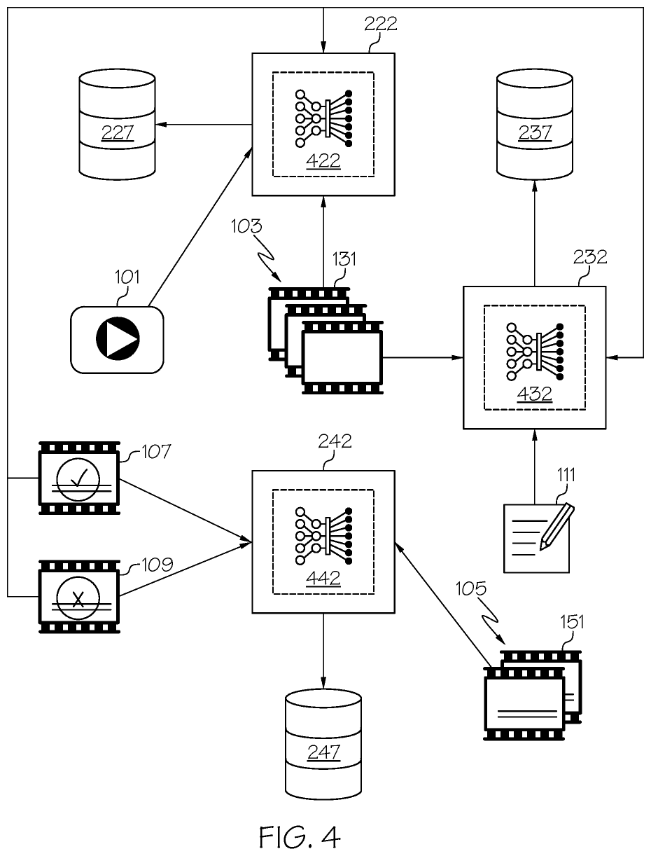

FIGS. 3 and 4 schematically depict block diagrams of the methods for facilitating annotation of videos. The controller 201 includes the frame segmentation module 222, the assignment module 232, and the quality control module 242. The frame segmentation module 222 may include a first neural network 422, the assignment module 232 may include a second neural network 432 and the quality control module 242 may include a third neural network 442. In some embodiments, the frame segmentation module 222, the assignment module 232, and the quality control module 242 may be combined into a single module including a single neural network fulfilling the frame segmentation, annotation task assignment, and annotation quality control functions.

Referring to FIG. 3, the frame segmentation module 222 may use the first neural network 422 to extract sequence frames 103 from the video 101 imported into the controller 201. The extraction of the sequence frames 103 may be based on the user-selected annotation task, which may include one or more guidelines. The frame segmentation module 222 may analyze the video 101 based on the selected annotation task to determine one or more sequence frames 103 that may be interesting to the user or/and be relevant to the annotation task. For example, the annotation task may be action recognition. The frame segmentation module 222 may select frames 131 including at least one human or animal. In embodiments, the frame segmentation module 222 may apply a frame segmentation model through the trained first neural network 432 to compare the historical frame and video data 227 to determine whether the sequence frames 103 may be interesting to the user or be relevant to the annotation tasks. The historical frame and video data 227 may include the selected annotation tasks by the user, the selected sequence frames 103, and the final flagged frames 109 and non-flagged frames 107. The trained first neural network 432 may inspect the video 101 in determining whether certain frames are interesting to the user or relevant to the annotation tasks based on the historical selected frames 103 associated with the selected sequence frames 103 and the selected annotation tasks by the user.

In response to the determination that the sequence frames 103 may be interesting to the user or be relevant to the annotation tasks, the frame segmentation module 222 may extract the sequence frames 103 and further determine if another set of sequence frames 103 may be of interest to the user or be relevant to the annotation tasks. The annotation facilitation system 100 may provide the proposed sequence frames 131 at the user interface 215 for the user to review and affirm for further operations.

The assignment module 232 may use the second neural network 432 to recommend or select one or more annotators 111 and transmit the sequence frames 103 to the selected annotators 111 based on matchability scores of the annotators 111 and historical annotation performance of the annotators 111.

In embodiments, the historical annotation performance of the annotators 111 may be included in the historical annotator assignment data 237 stored in the data storage component 207. The historical annotation performance of the annotators 111 may be determined based on, without limitations, annotating completion rates and rates of annotating disagreement with the user or other annotators 111.

In embodiments, the matchability scores of the annotators 111 may be determined based on distances between the annotation task and the historical annotation tasks performed by the annotators 111. The assignment module 232 may determine the distance between the annotation task and annotators' past tasks based on annotation task factors, such as, without limitations, the type of data, annotation complexity, domain specificity, and other guidelines of the annotations tasks and annotators' past tasks. The distance may be calculated as the square root of the sum of squared differences between the corresponding annotation task factors and annotator matchability factors. The annotators with the lowest distances between their historical tasks and the current annotation task may be assigned as the most matchable for the task. The annotator matchability factors for a human annotator may include, without limitation, the annotation skills, domain knowledge associated with the video 101, experience of annotations (e.g. experience length), annotation tools used by the human annotator, attention to detail, consistency in providing desirable quality of annotations, and speed and efficiency. The annotator matchability factors for a non-human annotator may include, without limitations, AI model selection, training data, model fine-tuning, scalability, customization, and cost-effectiveness.

The assignment module 232 may further monitor the annotation progress by generating annotation progress after assigning the annotation tasks to the annotator 111. The annotation progress may include completion rates, accuracy, and inter-annotator agreement (IAA). Completion rates may be determined based on the extent to which the frames 103 or the video 101 has been reviewed and annotated. Accuracy may be determined based on the correctness of the annotations via manual or AI-based sample checking. The IAA may be performed by selecting one or more samples of the annotations of the sample frames, which are independently labeled or annotated by different annotators following the annotation tasks and guidelines. The assignment module 232 may adopt IAA agreement metrics, such as Cohen's Kappa or percentage agreement, to quantitatively measure the level of agreement between different annotators 111. Desirable IAA may be found in the metrics having a high score of a numerical assessment of consensus. When the assignment module 232 determines that the annotation progress performed by an annotator 111 is below an annotation performance threshold based on the progress rate, accuracy and IAA score, the assignment module 232 may notify the user or/and the annotator 111.

After the annotator 111 completes the annotation task and transmits the annotated sequence frames 105 to the user controller 201 via the network 250, the quality control module 242 may screen and evaluate the annotations using the third neural network 442. The quality control module 242 may conduct a quality check over the annotated sequence frames 105. The quality control module 242 may determine whether the annotations in the annotated frames 151 comply with the task guidelines. For example, the annotations may label recognized human actions, such as walking, running, dancing, or other human activities, while the annotation tasks provide guidance to label recognized human poses, such as 2D point-line poses of head, neck, shoulders, elbows, ankles, and wrists.

In some embodiments, the quality control module 242 may include a machine-learning algorithm to calculate the confidence score for each annotation. The confidence score may be between 0 and 1, where 0 represents low confidence and 1 represents high confidence. The quality control module 242 may further determine whether the confidence scores of the annotations are beyond a threshold. In embodiments, the quality control module 242 may find confidence scores in the annotations below the threshold when more than a predetermined percentage of the annotations in the one or more annotated frames 151 deviates from the task guidelines or the labeled content. The confidence score may be determined by various factors, such as the complexity of the annotation tasks, cost efficiency, or acceptable error rate. In some embodiments, the threshold may be any deviation from the guidelines or labeled content. In some other embodiments, the threshold may be 1%, 2%, 3%, 4%, 5%, 6%, 7%, 8%, 9%, 10%, 20%, 30%, 40%, 50%, 60%, 70%, 80%, 90%, or any number between 0% and 100% of deviations from the guidelines or labeled content.

The quality control module 242 may flag the one or more annotations in the annotated frames 151 when the confidence scores of the annotations are below a threshold value. In some embodiments, the quality control module 242 may flag the annotated frame 151 based on a weighted confidence score of all the annotations in the annotated frame 151. The flagged annotated frame 109 may be notified to the user or/and the annotator 111 who generates the associated flagged annotated frame 109. The user and/or the annotator 111 may review the flagged annotation and conduct further actions, such as annotation corrections. The quality control module 242 may label any annotated frame 151 as a non-flagged annotated frame 107 when the annotated frame 151 has a confidence score of the annotations equal or beyond a threshold value. The system 100 may take no further actions on the non-flagged annotated frames 107. In some embodiments, the system 100 may notify the user that all annotated frames 151 in the annotated sequence frames 105 are non-flagged annotated frames 107 when no annotated frame 151 is flagged.

In embodiments, the neural networks, including the first neural network 422, the second neural network 432, and the third neural network 442, may include an encoder, one or more layers of hidden layers, and a decoder. The neural networks may feed training data during the pre-training process into the encoder to generate a lower-dimensional representation of the target input-output pairs. The neural networks may feed the encoder with historical data, such as historical frame and video data 227, historical annotator assignment data 237, and historical annotation data 247, for continuation training. For example, the lower-dimensional representation may include input of videos and annotation tasks pairing with output of selected sequence frames for annotation, output of selected annotators, or output of flagged annotations.

In some embodiments, the encoder or/and the decoder may be conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the selected frame data, selected annotator data, or annotation confidence score data throughout the frames 131, the annotators 111, or the annotation platform, using cumulative layer normalization. The outputs may be normalized and converted using an activation function for training and verification purposes, as described in detail further below. The activation function may be linear or nonlinear. The activation function may be, without limitations, a Sigmoid function, a Softmax function, a hyperbolic tangent function (Tanh), or a rectified linear unit (ReLU).

FIG. 4 depicts an example graphical representation of training the neural networks 422, 432, and 442 for facilitating annotation of videos. The neural networks 422, 432, and 442 may be pre-trained with training data, including, without limitations, sample input videos, sample annotation tasks, sample sequence frames for annotation, sample annotators (including both human annotators and non-human annotators), sample annotation platform, sample annotated frames, sample flagged frames, and sample non-flagged frames.

The first neural network 422 may be continuously trained with the videos 101, the selected annotation tasks by the user, the selected sequence frames 103, and the final flagged frames 109 and non-flagged frames 107. In some embodiments, the sequence frames 103 generated by the first neural network 422 may be validated based on historical manual selections of frames 131 in the historical videos associated with historical annotation tasks and the feedback of historical frame selections from the user. The training results of the first neural network 422 may be combined into the historical frame and video data 227 stored in the data storage component 207.

The second neural network 432 may be continuously trained with the annotation performance by selected annotators 111, the selected sequence frames 103, and the flagged frames 109 and non-flagged frames 107. In some embodiments, the generated annotator selection generated by the second neural network 432 may be validated based on the historical annotator selections by the user in association with the annotation task and feedback of the generated assignment by the assignment module 232. The training results of the second neural network may be combined into the historical annotator assignment data 237 stored in the data storage component 207.

The third neural network 442 may be continuously trained with the annotated sequence frames 105 including the annotated frames 151, the flagged frames 109, and non-flagged frames 107. In some embodiments, the flagged frames 109 and the non-flagged frames 107 generated by third neural network 442 may be validated based on the feedback of the flagged annotation from the user and manual flags marked by the user. The training results of the third neural network 442 may be combined into the historical annotation data 247 stored in the data storage component 207.

In embodiments, the neural networks, such as, the first neural network 422, the second neural network 432, or the third neural network 442, may be trained based on the activation functions mentioned further above. The encoder may generate encoded input data h=(Wx+b) that is transformed from the input data of one or more input channels. The encoded input data of one of the input channels may be represented as hᵢⱼ=g(Wxᵢⱼ+b) from the raw input data xᵢⱼ, which is then used to reconstruct output \tilde{x}ᵢⱼ=f(W^{T}hᵢⱼ+b′). The neural networks may reconstruct outputs, such as the selected sequence frames 103, the selected annotators 111, or the flagged frames 109 and the non-flagged frames 107, into x′=(W^{T}h+b′), where W is weight, b is bias, W^{T} and b′ are transverse values of W and b and are learned through back propagation. In this operation, the neural networks may calculate, for each input data, a distance between an input data x and a reconstructed input data x′, to yield a distance vector |x−x′|. The neural networks may minimize the loss function which is a utility function as the sum of all distance vectors. The training process may enable the neural network to learn linear or non-linear representations of the input data. The accuracy of the predicted output may be evaluated by satisfying a preset value, such as a preset accuracy and area under the curve (AUC) value computed using an output score from the activation function (e.g. the Softmax function or the Sigmoid function). For example, the annotation facilitation system 100 may assign the preset value of the AUC with the value of 0.7 to 0.8 as an acceptable simulation, 0.8 to 0.9 is as an excellent simulation, or more than 0.9 as an outstanding simulation. After the training satisfying the preset value, the updated neural networks 422, 432, 444, are stored in the frame segmentation module 222, the assignment module 232, and the quality control module 242, respectively, which are used to process the videos 101 for annotations, as illustrated in FIGS. 1 and 3.

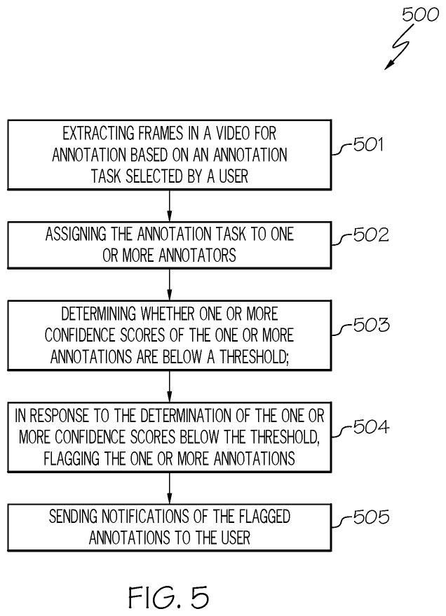

Referring to FIG. 5, flow diagram of the method 500 for facilitating annotation of videos is depicted. At block 501, the method 500 for facilitating annotation of videos 101 includes extracting, using trained first neural networks 422, frames 103 in a video 101 for annotation based on an annotation task selected by a user. In embodiments, the annotation tasks may be selected from, without limitations, object recognition and detection, segmentation, pose estimation, action recognition, attribute recognition of people, or a combination thereof.

At block 502, the method 500 for facilitating annotation of videos 103 includes assigning, using the trained second neural networks 432, the annotation task to one or more annotators 111 based on matchability scores and historical annotation performance of the annotators 111. In embodiments, the matchability scores of the annotators may be determined based on distances between the annotation task and the historical annotation tasks performed by the annotators. The historical annotation performance of the annotators may be determined based on annotating completion rates and rates of annotating disagreement with the user or other annotators. The annotators 111 may be one or more servers 301 or persons on an annotation platform. In some embodiments, after assigning, the method 500 for facilitating annotation of videos 103 may further include monitoring the annotation progress. The annotation progress may include, without limitations, completion rates, accuracy, and IAA.

At block 503, the method 500 for facilitating annotation of videos 103 includes determining, using the third neural networks 442, whether one or more confidence scores of the one or more annotations in the annotated frames 151 received from the one or more annotators 111 are below a threshold. At block 504, the method 500 for facilitating annotation of videos 103 includes in response to the determination of the one or more confidence scores below the threshold, flagging the one or more annotations associated with the one or more confidence scores below the threshold. At block 505, the method 500 for facilitating annotation of videos 103 includes sending notifications of the flagged annotations to the user.

In embodiments, the first neural network 422 may be trained based on the historical manual selections of frames 131 in historical videos 101 associated with historical annotation tasks and the feedback of historical frame selections from the user. The second neural network 432 may be trained based on the historical annotator 111 selections by the user in association with the annotation task and feedback of the automatic assignment. The third neural network 442 may be trained based on the feedback of the flagged annotation from the user and manual flags marked by the user.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A method for facilitating human annotation of videos comprising:
extracting, using one or more trained neural networks, frames in a video for annotation based on an annotation task selected by a user;
assigning, using the one or more trained neural networks, the annotation task to one or more annotators based on matchability scores and historical annotation performance of the annotators;
determining, using the one or more trained neural networks, whether one or more confidence scores of one or more annotations in annotated frames received from the one or more annotators are below a threshold;
in response to a determination that the one or more confidence scores are below the threshold, flagging the one or more annotations associated with the one or more confidence scores below the threshold; and
sending notifications of the flagged annotations to the user.

2. The method of claim 1, wherein the matchability scores of the annotators are determined based on distances between the annotation task and historical annotation tasks performed by the annotators.

3. The method of claim 1, wherein the historical annotation performance of the annotators is determined based on annotating completion rates and rates of annotating disagreement with the user or other annotators.

4. The method of claim 1, wherein the annotators are one or more servers or persons on an annotation platform.

5. The method of claim 1, wherein after assigning, the method further comprises monitoring annotation progress, the annotation progress comprising completion rates, accuracy, and inter-annotator agreement.

6. The method of claim 1, wherein the method further comprises sending the notifications of the flagged annotations to the one or more annotators.

7. The method of claim 1, wherein the annotation task is selected from object recognition and detection, segmentation, pose estimation, action recognition, attribute recognition of people, or a combination thereof.

8. The method of claim 1, wherein the one or more trained neural networks are trained based on historical manual selections of frames in historical videos associated with historical annotation tasks and feedback of historical frame selections from the user.

9. The method of claim 1, wherein the one or more trained neural networks are trained based on historical annotator selections by the user in association with the annotation task and feedback of generated assignment.

10. The method of claim 1, wherein the one or more trained neural networks are trained based on feedback of the flagged annotations from the user and manual flags marked by the user.

11. A system for facilitating human annotation of videos comprising a processor and a non-transitory, computer-readable medium storing one or more neural networks, the processor is operable to:
extract, using the one or more trained neural networks, frames in a video for annotation based on an annotation task selected by a user;
assign, using the one or more trained neural networks, the annotation task to one or more annotators based on matchability scores and historical annotation performance of the annotators;
determine, using the one or more trained neural networks, whether one or more confidence scores of one or more annotations in annotated frames received from the one or more annotators are below a threshold;
in response to a determination that the one or more confidence scores are below the threshold, flag the one or more annotations associated with the one or more confidence scores below the threshold; and
send notifications of the flagged annotations to the user.

12. The system of claim 11, wherein the matchability scores of the annotators are determined based on distances between the annotation task and historical annotation tasks performed by the annotators.

13. The system of claim 11, wherein the historical annotation performance of the annotators is determined based on annotating completion rates and rates of annotating disagreement with the user or other annotators.

14. The system of claim 11, wherein the annotators are one or more servers or persons on an annotation platform.

15. The system of claim 11, wherein after assigning the annotation task, the processor is operable to further monitor annotation progress, the annotation progress comprising completion rates, accuracy, and inter-annotator agreement.

16. The system of claim 11, wherein the processor is operable to further send the notifications of the flagged annotations to the one or more annotators.

17. The system of claim 11, wherein the annotation task is selected from object recognition and detection, segmentation, pose estimation, action recognition, attribute recognition of people, or a combination thereof.

18. The system of claim 11, wherein the one or more trained neural networks are trained based on historical manual selections of frames in historical videos associated with historical annotation tasks and feedback of historical frame selections from the user.

19. The system of claim 11, wherein the one or more trained neural networks are trained based on historical annotator selections by the user in association with the annotation task and feedback of generated assignment.

20. The system of claim 11, wherein the one or more trained neural networks are trained based on feedback of the flagged annotations from the user and manual flags marked by the user.
